(19) United States
(12) Patent Application Publication
(10) Pub. No.: US 2024/0176513 A1
(43) Pub. Date: May 30, 2024

(54) DIGITAL RESOURCE ACCESS CONTROL SYSTEM AND METHOD

(71) Applicant: Torsion Information Security Limited, London (GB)

(72) Inventor: Peter Glenn BRADLEY, London (GB)

(73) Assignee: Torsion Information Security Limited, London (GB)

(21) Appl. No.: 18/524,304

(22) Filed: Nov. 30, 2023

(30) Foreign Application Priority Data
Nov. 30, 2022 (GB) 2218039.2

(51) Int. Cl. G06F 3/06

(52) U.S. Cl. CPC G06F 3/0622; G06F 3/0655; G06F 3/067

(57) ABSTRACT

A digital resource access control system and method comprising for controlling access to a digital resource stored on an information management system to reflect context of a reason for access and the circumstances of a user in a cloud environment for unstructured data.

### FIELD OF THE INVENTION

The present invention relates to a digital resource access control system and method. More particularly, but not exclusively, it relates to a digital resource access control system and method for controlling access to a digital resource stored in a distributed storage environment, for example cloud based storage.

### BACKGROUND TO THE INVENTION

Digital resource access control systems aim to maintain the security of a digital resource, for example data, an application or a digital wallet, by controlling the match between who should have access to specific a digital resource and who actually does have access to the specific the digital resource. In an ideal system there is no instance of people having unauthorised or inappropriate access to the digital resource.

A further aim of digital resource access control systems is to reduce the maintenance of access control configurations, for example an employee's change of role, department, location or assignment access controls configurations must be updated to reflect their new circumstances. Typically, this will include the deletion of outdated configurations and the addition of updated configurations appropriate to the employee's new circumstances. Such repeated amendments to access control configurations carries with it the inherent risk of errors and also ties up human resources.

Additionally, merely having an access controls configuration for a single user does not provide the system wide agility necessary to allow for a user having multiple roles or requiring temporary access to digital resources associated with a previous set of circumstances, for example during a handover period to their successor when changing roles.

There are a number of digital resource access control protocols currently in use.

Access Control Lists (ACLs) in which the users permitted to access a digital resource are compiled in lists which are then referenced whenever a request to access the digital resource is made. These lists are manually maintained and the approach is flexible. However, maintaining the lists is highly laborious and error-prone. Additionally, even a small-medium sized enterprise will typically have many thousands of such lists to maintain across their cloud-based unstructured information management systems.

Role-Based Access Control (RBAC) in which access to a digital resource is based upon the user's role. For example, a resource may permit access to any user with ‘Role=Manager’. In the RBAC approach a user's access to resources is updated automatically when their role changes. This removes the need for regular manual maintenance of resource access control lists which is laborious and error-prone. However, RBAC is single-dimensional, meaning it is not capable of granting access to users with both ‘Role=Manager AND Department=Finance’. RBAC is an imprecise approach of defining who needs access to digital resources as it assumes that every user has exactly one role. This means that RBAC is highly inflexible, and a coarse representation an organisation's structure which is typically more fluid and nuanced that RBAC can represent.

Attribute-Based Access Control (ABAC) is based on matching combinations of assertions about users, with rules assigned to a particular digital resource. For example, ABAC can grant access to users with both ‘Role=Manager AND Department=Finance’. This offers the advantage of being more precise than RBAC, whereby a person's access to the digital resource is adjusted automatically when any of the relevant aspects of their circumstances change.

However, the current approaches are unsuitable for controlling access within volumes of digital resources in cloud-based unstructured information systems due to three technical drawbacks.

Firstly, there is an assumption in the ABAC approach that the organisational structure of the entity for which the digital resources are being managed is rigid, highly constrained and clearly defined. There is no scope to allow for gradual or overlapping changes in a user's access rights, nor is there the ability to allow a user account to simultaneously fulfil more than one role (such as a person temporarily covering for another person who is away on holiday) within the organisational structure for digital resource access purposes. However, such fluidity in organisational structure is commonplace.

Secondly, there is an assumption in the ABAC that the commercial, security and compliance implications of the digital resource are fully understood by the person allocating access to the digital resource at the time they are allocating access, sufficient to enable well-informed decisions about how access should be allocated. However, due to the technical nature of these decisions and their resultant configurations, such efforts are forced onto technical personnel, who do not typically possess the necessary understanding of the commercial, security and compliance implications of the digital resources. It is further assumed that the commercial, security and compliance implications of the digital resource remains largely static, and the rate of necessary change in access allocations is low enough that it can be managed manually. However, cloud-based unstructured information systems are very dynamic, with users constantly creating and sharing files, folders and data containers, so the set of access allocations must be decided and maintained at a volume and a rate considerably beyond what could be manually overseen.

Thirdly, cloud-based unstructured information systems do not support integration of digital resource access control systems at the authorisation layer, which prevents the use of ABAC systems and methods with cloud-based information systems. Current cloud-based unstructured information systems typically use ACL based protocols to control access to digital resources, see for example FIG. 1, with the attendant problems listed hereinbefore, thereby requiring high degrees of maintenance and administrator interaction in order to maintain accurate user access across the set of digital resources within the constraints of the ACL based protocols.

The present invention mitigates, at least partially, at least one of the above stated problems associated with existing ABAC systems and methods.

### SUMMARY OF THE INVENTION

According to a first aspect of the present invention there is provided a digital resource access control system comprising:
an integration layer configured to interface with an information management system;
   an access orchestration engine configured to determine user access controls;
a context change detection engine configured to determine a change in contextual data related to a given user;
an access control list automation engine configured to update an access control list data structure associated with at least one digital resource; wherein
the context change detection engine is configured to receive input data relating to at least one attribute associated with at least one user, compare the input data to current attribute data associated with the at least one user and to output a trigger message comprising the input data to the access orchestration engine in response to detecting a difference between the input data and the current attribute data;
the access orchestration engine is configured to receive the trigger message and to determine access controls to digital resources based upon input data and to send an update message to the access control list automation engine;
the access control list automation engine is configured to update at least one access control data structure based upon the update message and to output the updated at least one access control data structure to the access orchestration engine, which is further configured to pass the access control data structure to the integration layer; and
the integration layer is configured to control an access control database of the information management system and to update the access control database in response to receiving the at least one access control data structure received from the access orchestration engine, such that in use, access to data is controlled in accordance with at least one entry in the access control database.

Such an access control system provides flexible, robust data access control and security schema which, at least partially, addresses the shortcomings of the prior art as noted hereinbefore. Such a real-time and typically automated update of user circumstances yields data access permissions that more closely reflect the true requirements of the organisation and thereby provide improved data security and compliance than prior art solutions. In contrast to existing systems the present invention determines who ‘should’ have access, comparing it with who ‘does’ have access, then takes action on the differences on a constant, ongoing basis. There is no dependency on analysing data access requests and the system is not event-driven.

The integration layer may be configured to interrupt or modify communication between an access control list user interface of the information management system and the access control database of the information management system. The integration layer may be configured to replace or modify an input from the access control list user interface of the information management system to the access control database of the information management system with the at least one access control data structure. The integration layer may be arranged to assume control of the access control database of the information management system. The integration layer may be configured to communicate with at least one application programming interface (API) of the information management system.

The digital resource access control system may further comprise an access detection engine configured to analyse the state of the access control database of the information management system, to determine if a user's data access corresponds to a user's allowed data access based upon the attribute data associated with the user. The access detection engine may be further configured to output a message to the access orchestration engine detailing the differences between a user's data access and a user's allowed data access, which may include data access which should not be permitted. The access detection engine may be further configured to output data detailing access which should not be permitted wherein the attribute data associated with the user and reasons for access provided by the user indicates that said access is impermissible.

The access control list automation engine may be configured to automate control of the access control database of the information management system. The access control list automation engine may be configured to programmatically create and/or amend entries within the access control database in response to messaging from the access orchestration engine.

The digital resource access control system may further comprise an access reporting engine configured to receive a notification from the access orchestration engine regarding the state of the access control database. The access reporting engine may also be configured to receive a notification from the access detection engine regarding data access which should not be permitted. The access reporting engine may be configured to generate at least one report detailing at least one of the following: user access permissions, user activity, attribute context, temporal variations in user access permissions, impermissible access.

The digital resource access control system may further comprise a user interface arranged to receive user input corresponding to the at least one attribute associated with a, or the, user. The user interface may be arranged to receive user input describing the at least one reason why a user may be permitted to have access to a digital resource, whereby a reason may be expressed in a manner which is simple for a user not having a technical background to understand. The user interface may be configured to output the at least one report generated by the access reporting engine.

The access orchestration engine may be configured to receive input data from at least one of the following to determine access controls to digital resources based upon said input data: access detection engine, context change detection engine, access control list automation engine, access reporting engine, user interface, integration layer.

The information management system may be cloud based. The information management system may store unstructured data.

According to a second aspect of the present invention there is provided a computer implemented method of controlling access to a digital resource in an information management system by a digital resource access control system comprising the steps of:
comparing input data relating to at least one attribute associated with at least one user to current attribute data associated with the at least one user by the context change detection engine;
outputting a trigger message comprising the input data to an access orchestration engine in response to detecting a difference between the input data and the current attribute data by the context change detection engine;
determining access controls to at least one digital resource stored in the information management system by the access orchestration engine based upon input data;
outputting an update message to an access control list automation engine; updating at least one access control data structure based upon the update message by the access control automation engine;
outputting the updated at least one access control data structure to the access orchestration engine from the access control automation engine; passing the access control data structure to an integration layer configured to interface with the information management system; and
updating an access control database of the information management system by the integration layer in response to receiving the at least one access control data structure received from the access orchestration engine.

The method may further comprise interrupting, modifying or augmenting communication between an access control list user interface of the information management system and the access control database of the information management system. The method may comprise replacing, modifying or augmenting an input from the access control list user interface of the information management system to the access control database of the information management system with the at least one access control data structure. The method may comprise assuming control of the access control database of the information management system by the integration layer. The method may comprise communicating with at least one application programming interface (API) of the information management system by the integration layer.

The method may comprise analysing the state of the access control database of the information management system, to determine if a user's data access corresponds to a user's allowed data access based upon the attribute data associated with the user. The method may further comprise outputting a message to the access orchestration engine detailing the differences between a user's data access and a user's allowed data access, which may include data access which should not be permitted.

The method may comprise automating control of the access control database of the information management system. The method may comprise programmatically creating and/or amending entries within the access control database by the access control list automation engine in response to messaging from the access orchestration engine.

The method may comprise receiving a notification from the access orchestration engine regarding the state of the access control database. The method may also comprise receiving a notification from the access detection engine regarding data access which should not be permitted. The method may comprise generating at least one report at the access reporting engine detailing at least one of the following: user access permissions, user activity, attribute context, temporal variations in user access permissions, impermissible access.

The method may comprise receiving user input corresponding to the at least one attribute associated with a, or the, user. The method may also comprise receiving user input describing the at least one reason why a user may be permitted to have access to a digital resource, whereby a reason may be expressed in a manner which is simple for a user not having a technical background to understand. The method may comprise outputting the at least one report generated by the access reporting engine.

The method may comprise receiving input data from at least one of the following by the access orchestration engine to determine access controls to digital resources based upon said input data: access detection engine, context change detection engine, access control list automation engine, access reporting engine, user interface, integration layer.

The information management system may be cloud based. The information management system may store unstructured data.

According to a third aspect of the present invention there is provided a processor arranged to execute the method of the second aspect of the present invention.

According to a fourth aspect of the present invention there is provided a server comprising the processor of the third aspect of the present invention.

According to a fifth aspect of the present invention there is provided a computer readable medium having encoded thereupon instructions which, when executed on a processor, cause the processor to execute the method of the second aspect of the present invention.

According to a sixth aspect of the present invention there is provided an access orchestration engine configured to determine user access controls for at least one digital resource stored in an information management system based upon the output of an access detection engine which is arranged to compare input data to current attribute data associated with at least one user and to output a trigger message comprising the input data to the access orchestration engine in response to detecting a difference between the input data and the current attribute data, and being further configured to pass an access control data structure reflective of the user access controls to an access control database of the information management system.

The access orchestration engine may be configured to provide instructions to an access control list automation engine configured to programmatically create and/or amend entries within the access control database in response to messaging from the access orchestration engine.

The access orchestration engine may be configured to receive input data from at least one of the following to determine access controls to digital resources based upon said input data: an access detection engine, the context change detection engine, the access control list automation engine, an access reporting engine, a user interface, the integration layer.

The information management system may be cloud based. The information management system may store unstructured data.

According to a seventh aspect of the present invention there is provided a processor arranged to execute instructions which cause the processor to act as the access orchestration engine of the sixth aspect of the present invention.

According to an eighth aspect of the present invention there is provided a server comprising the processor of the seventh aspect of the present invention.

According to a ninth aspect of the present invention there is provided a computer readable medium having encoded thereupon instructions which, when executed on a processor, cause the processor to act as the orchestration engine of the sixth aspect of the present invention of the sixth aspect of the present invention.

### BRIEF DESCRIPTION OF THE DRAWINGS

The present invention will now be described, by way of example only, with reference to the accompanying drawings, in which:

FIG. 1 is a schematic representation of a digital resource access control system according to the present invention coupled to a cloud based information management system;

FIG. 2 is a schematic representation of the digital resource access control system of FIG. 1;

FIG. 3 is a representation of a user interface of the digital resource access control system of FIGS. 1 and 2; and

FIG. 4 is a flowchart detailing a provided a computer implemented method of controlling access to a digital resource in an information management system according to an aspect of the present invention.

### DETAILED DESCRIPTION OF PARTICULAR EMBODIMENTS

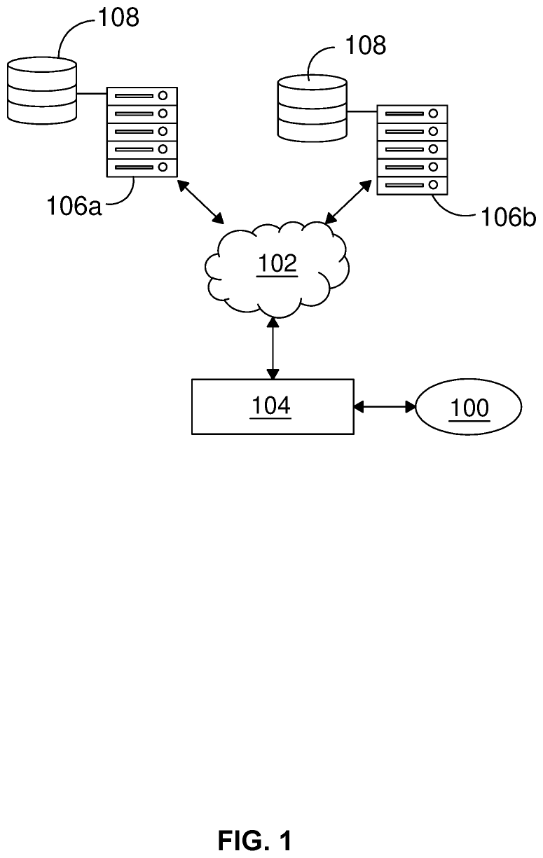

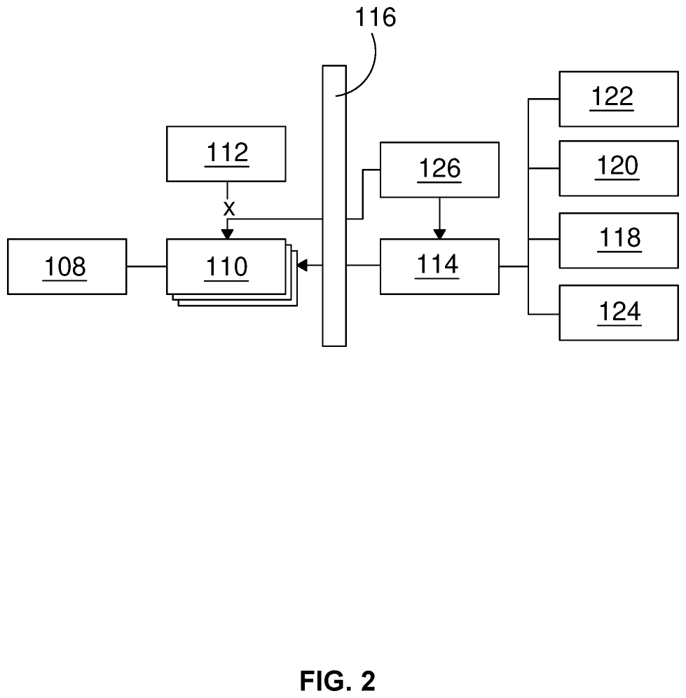

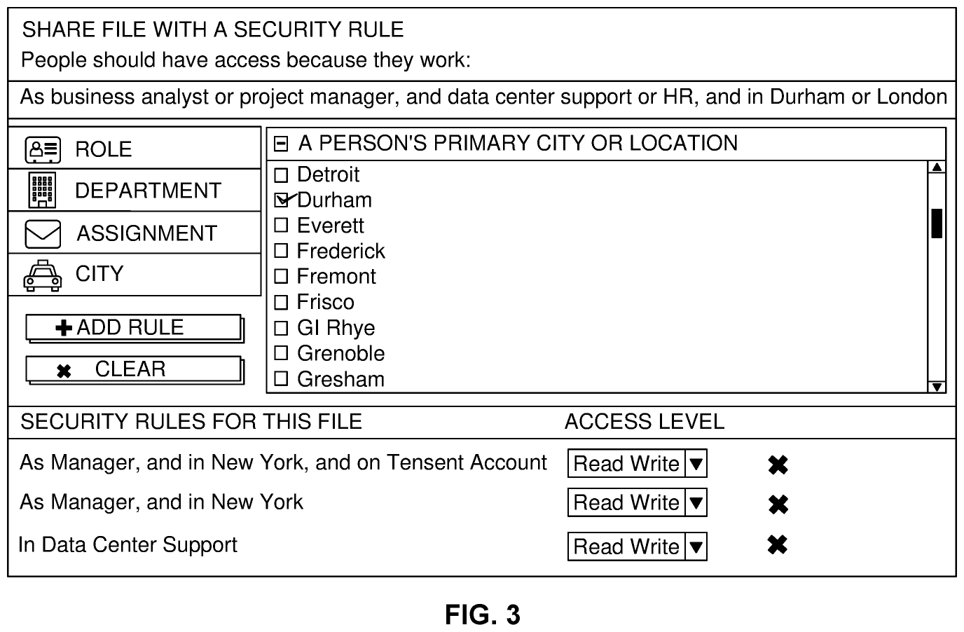

Referring now to FIGS. 1a to 3, a digital resource access control system 100 is coupled to a cloud based information management system 102 via a network 104, typically the Internet but which could be a proprietary or otherwise secure network. The cloud based information management system 102 comprises at least one, but more typically a plurality of servers 106 a,b, each of which stores unstructured data, typically in the form of files 108.

Each file 108 has associated with it a set of access permissions that relate to which user can legitimately access the respective files 108. The files 108 can be any form of data file, for example, but not limited to, database records, images, video, audio, document, email, chat room, message, financial account details, medical records etc., all of which require access permissions in order to prevent unauthorised access of the data associated with each file. The term as used herein covers files, folders, data containers or any other type of unstructured data.

The information management system 102 further comprises access control lists (ACLs) 110, an access control list maintenance user interface (AMUI) 112 in addition to the files 108. The ACLs 110 set out which user has permission to access which file 108. The AMUI 112 provides an input mechanism for a user, such as a systems administrator or cyber security engineer to alter the permission entries in the ACLs 110 or to create new or delete existing permission entries in the ACLs 110.

The digital resource access control system 100 comprises an access orchestration engine (AOE) 114, an integration layer (IL) 116, an access control list automation engine (AA) 118, a user context change detection engine (UCCD) 120, an access detection engine (AD) 122, an access reporting engine (AR) 124 and user interface 126 and is typically operated upon a server 127.

The integration layer 116 controls the flow of information between the access control system 100 and the information management system 102, typically by communicating with one or more APIs of the information management system 102. In use, the integration layer 116 interrupts or modifies the communication channel between the AMUI 112 and the ACLs 110 such that the digital resource access control system 102 assumes control of updating, creating or amending permission entries in the ACLs 110.

In a set up configuration the ACLs 110 are populated either by direct user input via the AMUI 112 in the case of a historic integration of the digital resource access control system 100 to the information management system, or via the user interface 126 in the case of an integrated digital resource access control system 100 and information management system 102 set up. Alternatively or additionally, the ACLs 110 can be populated via a file transfer mechanism from a pre-populated file.

The integration layer 116 receives messaging detailing the state of the ACLs 110 within the information management system 102 and passes these messages to the AOE 108 which in turn passes them to the AD 122.

The AD 122 analyses the messages, to determine if data is accessible by a user who should not have access to it. For example, this analysis comprises executing a software routine to correlate the ACLs 110 with the reasons why users may have access to data according to input received via the user interface 126, to determine whether a user should have access to the relevant piece of data. The AD 122 passes data relating to any inappropriate file access back to the AOE 108 such that the AOE 108 can incorporate details of the inappropriate file access into future determinations of file access permissions. Additionally, or alternatively, the AD 122 passes the passes data relating to any inappropriate file access to the user interface 126 where it can be flagged to, for example, the data owner or a system administrator or security or compliance officer in order that data access permissions can be varied via the user interface 126 if appropriate or remedial action taken to prevent further inappropriate data access by the specified user.

The UCCD 120 analyses one or more parameters associated with a user in order to provide context to decisions regarding changes to user data access permissions. For example, if a user is temporarily assigned to a project, is covering for a colleague's holiday, holds multiple roles or is promoted within an organisation this context is collated in the UCCD 120. The UCCD 120 collects these details either from direct input via the user interface 126 or from scraping internal data sources, for example org charts, human resource databases and project team listings. The UCCD 120 can recognise transitional states, for example when a user transitions from one stage to another and can flag these to allow for user access to facilitate handover of responsibilities to the new incumbent.

The user interface 126 can be instantiated only once or multiple times across a number of client terminals. The user interface 126 provides an interface whereby non-technical users, i.e., not systems administrators or technical support staff, can input parameter values which feed in to the allocation of permissions for any given file 108.

In use, the AOE 114 derives who should have access to a digital resource by interpreting why they should have access, i.e., it intersects the reasons why a user should qualify for access to each digital resource, with the relevant aspects of the users' circumstances, to determine which users meet the criteria specified in the reason. This yields a knowledge of which users ‘should’ have access to each digital resource. By way of non-limiting example, the engine receives input and coordinates among the other modules. For example, the reasons come from the user interface 126, the user circumstances come from the UCCD 120 engine, and the resulting outputs are actioned by the AA 118.

For example, a project manager can nominate the reasons why users should have access to their project documents, such as ‘project team members with technical roles’ should have access to a folder, ‘project team members in the finance department in admin roles’ should have access to another folder, ‘programme oversight board’ should have access to another folder, and ‘all project managers’ should have access to all project folders.

The availability of the user interface 126 to any data owner (in the example, the project manager) distributes the workload and responsibility for submitting the reasons for access to the files 108 to those closest to the data, who have the best understanding of the commercial, security and compliance implications of the data, are most likely to make optimal decisions regarding why and who should have access to it, and therefore improves the accuracy of the data access permissions across an organisation.

Incorporating the reasons provided as input to the user interface 126, with the changing circumstances of the users (such as changing assignments, roles, locations or departments) from the from the UCCD 120, the AOE 108 can determine which users should have access to the files 108, and automatically execute such entries in the ACLs 110 of the information management system 102 via the AA 118, reducing the need for human intervention in the permission allocation process.

The user interface 126 provides a means whereby a user, typically a data owner but also possibly a system administrator or security or compliance officer, can review both the contextual data relating to access permissions and reports relating to for example, which users have access to any given file 108, the access history of users, temporal changes in access patterns, potential inappropriate access to files 108 and the reasons why a user has access to a particular file 108. The reports output via the user interface 126 are typically generated in the AR 124. Alternatively, or additionally, the reports generated in the AR 124 may be printed as hardcopies. It will be understood that the user interface 126 may be provided as a web interface, a software application on a desktop or laptop computer, a thin client on a terminal or an app upon a mobile device such as, for example, a mobile telephone.

The AOE 114 receives inputs from the user interface 126, the UCCD 120 and the AD 122 and from theses inputs determines what access permissions are to be allocated to each individual file where a change is required such that the access permissions reflect the current state of the organisation for which they are being determined. Once the access permissions are determined the AOE 114 passes them to the AA 118 which communicates with the integration layer 116 to programmatically assign the updated access permissions to the ACLs 110 of the information management system 102. The updating of the access permissions can entail any one, or combination, of creation, population of, adjustments to, deletion or assignation of permissions within the ALCs 110. The AA 118 updates the ACLs 110 via the integration layer 116 by communicating with at least one application programming interface (API) of the information management system 102. The AOE 114 can assign a tapering data access permission, for example when a user is transitioning out of a role they may have full read-write permissions for a pre-defined period, which then transitions to read only for a pre-defined period and then no permissions, in order for the organisation to maintain accurate access permissions when user role transitions are gradual rather than immediate. These pre-defined periods can vary dependent upon user input via the user interface 126 or due to changes in context determined at the UCCD 120.

The AOE 114 operates repeatedly to update the data access permissions upon receipt of an input from any of the aforementioned input engines, the integration layer 116 or the user interface 126. Alternatively, or additionally, the AOE 114 operates repeatedly to update the data access permissions periodically. In either case, the data access permissions are maintained in such a way to match the organisational structure and needs of a given organisation.

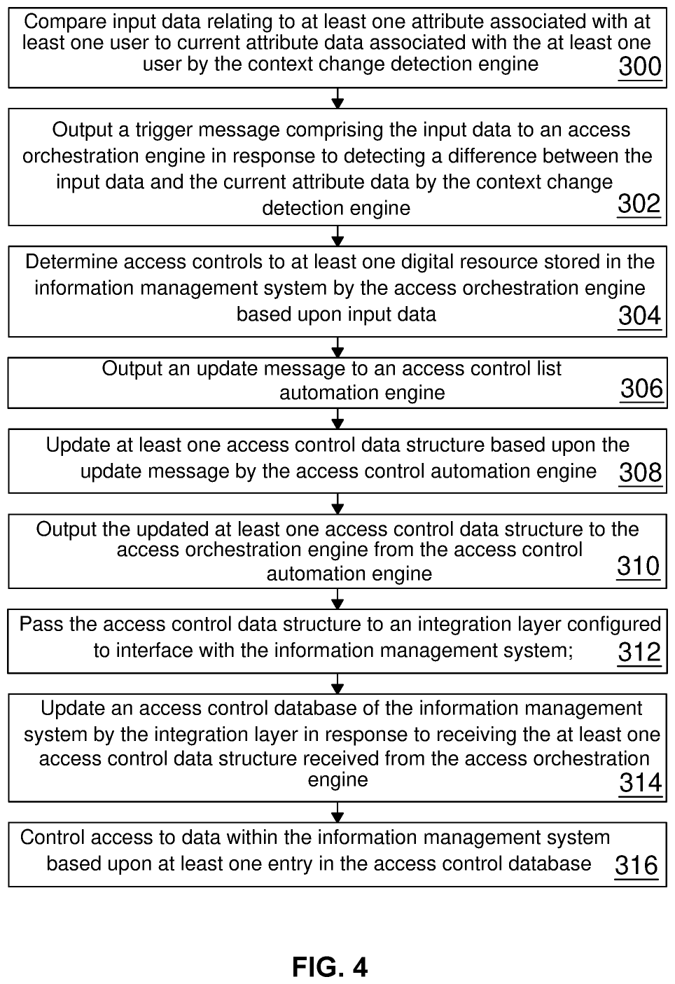

Referring now to FIG. 4, a computer implemented method of controlling access to a digital resource in an information management system by a digital resource access control system comprises comparing input data relating to an attribute associated with a user to current attribute data associated with the user by a context change detection engine (300). The context change detection engine outputs a trigger message comprising the input data to an access orchestration engine in response to detecting a difference between the input data and the current attribute data (302). An access orchestration engine determines access controls to at least one digital resource stored in the information management system based upon input data (304). An update message is output to an access control list automation engine (306). An access control data structure is updated based upon the update message by the access control automation engine (308). The updated access control data structure is sent to the access orchestration engine from the access control automation engine (310). The access control data structure passes to an integration layer configured to interface with the information management system (312). An access control database of the information management system is updated by the integration layer in response to receiving the access control data structure received from the access orchestration engine (314). Access to data within the information management system is controlled by the entries of the access control data structure. (316).

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A digital resource access control system comprising:
an integration layer configured to interface with an information management system;
an access orchestration engine configured to determine user access controls;
a context change detection engine configured to determine a change in contextual data related to a given user;
an access control list automation engine configured to update an access control list data structure associated with at least one digital resource; wherein
the context change detection engine is configured to receive input data relating to at least one attribute associated with at one least user, compare the input data to current attribute data associated with the at least one user and to output a trigger message comprising the input data to the access orchestration engine in response to detecting a difference between the input data and the current attribute data;
the access orchestration engine is configured to receive the trigger message and to determine access controls to digital resources based upon input data and to send an update message to the access control list automation engine;
the access control list automation engine is configured to update at least one access control data structure based upon the update message and to output the updated at least one access control data structure to the access orchestration engine, which is further configured to pass the access control data structure to the integration layer; and
the integration layer is configured to control an access control database of the information management system and to update the access control database in response to receiving the at least one access control data structure received from the access orchestration engine, such that in use, access to data is controlled in accordance with at least one entry in the access control database.

2. A system according to claim 1 wherein, the integration layer is configured to interrupt, augment or modify communication between an access control list user interface of the information management system and the access control database of the information management system and wherein, optionally, the integration layer is configured to replace, modify or augment an input from the access control list user interface of the information management system to the access control database of the information management system with the at least one access control data structure.

3. A system according to claim 1 wherein, the integration layer is arranged to assume control of the access control database of the information management system.

4. A system according to claim 1 wherein, the integration layer is configured to communicate with at least one application programming interface (API) of the information management system.

5. A system claim 1 comprising an access detection engine configured to receive access permissions data from the information management system and to analyse the access permissions data to determine if data access corresponds to a user's allowed data access based upon reasons for access provided by the data owner and the attribute data associated with the user and wherein, optionally, the access detection engine is further configured to output data detailing access which should not be permitted wherein the attribute data associated with the user and reasons for access provided by the user indicates that said access is impermissible and wherein, optionally, the access control list automation engine is configured to automate control of the access control database of the information management system.

6. A system according to claim 5, the access control list automation engine is configured to programmatically create and/or amend permissions within the access control database in response to messaging from the access orchestration engine.

7. A system according to claim 1 comprising an access reporting engine configured to receive a notification from the access detection engine when impermissible access is detected and wherein, optionally, the access reporting engine is configured to generate at least one report detailing at least one of the following: user access permissions, user activity, attribute context, temporal variations in user access permissions, impermissible access.

8. A system according to claim 1 comprising a user interface arranged to receive user input corresponding to the at least one reason why a user should have access to data and wherein, optionally, the user interface is configured to output the at least one report generated by a, or the, access reporting engine.

9. A system according to claim 1 wherein, wherein the access orchestration engine is configured to receive input data from at least one of the following to determine access controls to digital resources based upon said input data: access detection engine, context change detection engine, access control list automation engine, access reporting engine, user interface, integration layer.

10. A computer implemented method of controlling access to a digital resource in an information management system by a digital resource access control system comprising the steps of:
comparing input data relating to at least one attribute associated with at least one user to current attribute data associated with the at least one user by the context change detection engine;
outputting a trigger message comprising the input data to an access orchestration engine in response to detecting a difference between the input data and the current attribute data by the context change detection engine;
determining access controls to at least one digital resource stored in the information management system by the access orchestration engine based upon input data;
outputting an update message to an access control list automation engine;
updating at least one access control data structure based upon the update message by the access control automation engine;
outputting the updated at least one access control data structure to the access orchestration engine from the access control automation engine;
passing the access control data structure to an integration layer configured to interface with the information management system;
updating an access control database of the information management system by the integration layer in response to receiving the at least one access control data structure received from the access orchestration engine; and
controlling access to data within the information management system based upon at least one entry in the access control database.

11. The method of claim 10 further comprising interrupting, modifying or augmenting communication between an access control list user interface of the information management system and the access control database of the information management system and optionally further comprising replacing, modifying or augmenting an input from the access control list user interface of the information management system to the access control database of the information management system with the at least one access control data structure and optionally further comprising assuming control of the access control database of the information management system by the integration layer.

12. The method of claim 10 further comprising communicating with at least one application programming interface (API) of the information management system by the integration layer.

13. The method of claim 10 further comprising analysing the state of the access control database of the information management system, to determine if a user's data access corresponds to a user's allowed data access based upon the attribute data associated with the user and optionally further comprising outputting a message to the access orchestration engine detailing the differences between a user's data access and a user's allowed data access, which may include data access which should not be permitted.

14. The method of claim 10 further comprising automating control of the access control database of the information management system.

15. The method of claim 10 further comprising programmatically creating and/or amending entries within the access control database by the access control list automation engine in response to messaging from the access orchestration engine.

16. The method of claim 10 further comprising receiving user input corresponding to the at least one attribute associated with a, or the, user and optionally comprising receiving user input describing the at least one reason why a user may be permitted to have access to a digital resource.

17. The method of claim 10 further comprising generating at least one report at a, or the, access reporting engine detailing at least one of the following: user access permissions, user activity, attribute context, temporal variations in user access permissions, impermissible access and optionally further comprising outputting the at least one report generated by the access reporting engine.

18. The method of claim 10 further comprising receiving input data from at least one of the following by the access orchestration engine to determine access controls to digital resources based upon said input data: access detection engine, context change detection engine, access control list automation engine, access reporting engine, user interface, integration layer.

19. An access orchestration engine configured to determine user access controls for at least one digital resource stored in an information management system based upon the output of an access detection engine which is arranged to compare input data to current attribute data associated with at least one user and to output a trigger message comprising the input data to the access orchestration engine in response to detecting a difference between the input data and the current attribute data, and being further configured to pass an access control data structure reflective of the user access controls to an access control database of the information management system.

20. The access orchestration engine of claim 19 configured to provide instructions to an access control list automation engine configured to programmatically create and/or amend entries within the access control database in response to messaging from the access orchestration engine and optionally being configured to receive input data from at least one of the following to determine access controls to digital resources based upon said input data: an access detection engine, the context change detection engine, the access control list automation engine, an access reporting engine, a user interface, the integration layer.
